(19) United States
(12) Patent Application Publication
(10) Pub. No.: US 2024/0320990 A1
(43) Pub. Date: Sep. 26, 2024

(54) CAMERA PERCEPTION TECHNIQUES TO ANALYZE IMAGES FOR DRIVING OPERATION

(71) Applicant: TuSimple, Inc., SAN DIEGO, CA (US)

(72) Inventors: Rundong GE, San Diego, CA (US); Long SHA, San Diego, CA (US); Haiping WU, Burnaby (CA); Xiangchen ZHAO, San Diego, CA (US); Fangjun ZHANG, San Diego, CA (US); Zilong GUO, San Diego, CA (US); Hongyuan DU, San Diego, CA (US); Pengfei CHEN, San Diego, CA (US); Panqu WANG, San Diego, CA (US)

(21) Appl. No.: 18/598,715

(22) Filed: Mar. 7, 2024

Related U.S. Application Data
(60) Provisional application No. 63/492,122, filed on Mar. 24, 2023.

(51) Int. Cl. G06V 20/56; B60W 10/20; G06T 7/20; G06V 10/54; G06V 10/56; G06V 10/75; G06V 20/58

(52) U.S. Cl. CPC G06V 20/588; B60W 10/20; G06T 7/20; G06V 10/54; G06V 10/56; G06V 10/751; G06V 20/584

(57) ABSTRACT

Techniques are described for performing an image processing on frames of a camera located on or in a vehicle. An example technique includes receiving, by a computer located in a vehicle, a first image and a second image from a camera; determining a first set of characteristics about a first set of pixels in the first image and a second set of characteristics about a second set of pixels in the second image; obtaining a motion information for each pixel in the second set by comparing the second set of characteristics with the first set of characteristics; generating, using the motion information for each pixel in the second set, a combined set of characteristics; determining attributes of a road using at least some of the combined set of characteristics; and causing the vehicle to perform a driving related operation in response to the determining the attributes of the road.

### CROSS-REFERENCE TO RELATED APPLICATIONS

This document claims priority to and the benefit of U.S. Provisional Patent Application No. 63/492,122, filed on Mar. 24, 2023. The aforementioned application of which is incorporated herein by reference in its entirety.

### TECHNICAL FIELD

This document relates to systems, apparatus, and methods to perform image processing techniques on images or image frames provided by a camera on or in a vehicle for driving operation.

### BACKGROUND

Autonomous vehicle navigation is a technology that can allow a vehicle to sense the position and movement of vehicles around an autonomous vehicle and, based on the sensing, control the autonomous vehicle to safely navigate towards a destination. An autonomous vehicle may operate in several modes. In some cases, an autonomous vehicle may allow a driver to operate the autonomous vehicle as a conventional vehicle by controlling the steering, throttle, clutch, gear shifter, and/or other devices. In other cases, a driver may engage the autonomous vehicle navigation technology to allow the vehicle to be driven by itself.

### SUMMARY

This patent document describes systems, apparatus, and methods to perform image processing techniques on images or image to detect and/or to determine characteristic(s) of one or more object located in images obtained by a camera on or in a vehicle.

A method of driving operation includes receiving, by a computer located in a vehicle, a first image frame and a second image frame from a camera located on or in the vehicle, wherein the first image frame is received prior to the second image frame; determining a first set of characteristics about a first set of pixels in the first image frame and a second set of characteristics about a second set of pixels in the second image frame; obtaining a motion information for each pixel in the second set of pixels by comparing the second set of characteristics about the second set of pixels with the first set of characteristics about the first set of pixels; generating, using the motion information for each pixel in the second set of pixels, a combined set of characteristics associated with each pixel in the second set of pixels and each pixel from the first set of pixels; determining attributes of a road on which the vehicle is operating using at least some of the combined set of characteristics; and causing the vehicle to perform a driving related operation in response to the determining the attributes of the road.

In some embodiments, the obtaining the motion information for each pixel in the second set of pixels includes: determining, for each pixel in the second set of pixels, an extent to which a characteristic of a pixel in the second set of pixels has moved relative to the same characteristic of a corresponding pixel in the first set of pixels, wherein the motion information of the pixel indicates the extent to which the characteristic the pixel has moved from the first image frame to the second image frame. In some embodiments, the combined set of characteristics is generated for each pixel in the second set of pixels by: determining, for each pixel in the second set of pixels, that one pixel corresponds to another pixel in the first set of pixels using the motion information for the one pixel; and generating the combined set of characteristics for each pixel in the second set of pixels by combining, for each pixel in the second set of pixels, one or more characteristic of the one pixel in the second set of pixels with one or more characteristic of the another pixel in the first set of pixels.

In some embodiments, the determining the attributes of the road using the at least some of the combined set of characteristics comprises: determining, for each pixel in the second set of pixels, a category of information associated with a pixel. In some embodiments, the category of information includes a road, a terrain, a plantation, a vehicle, a traffic light, or a person. In some embodiments, the determining the attributes of the road using the at least some of the combined set of characteristics comprises: determining, for each pixel in the second set of pixels and by using the combined set of characteristics for each pixel in the second set of pixels, whether a pixel is associated with a lane marker of a lane on the road.

In some embodiments, the determining the first set of characteristics and the second set of characteristics include determining, for each pixel in the first image frame, the first set of characteristics, and determining, for each pixel in the second image frame, the second set of characteristics. In some embodiments, the first image frame is received immediately prior to the second image frame. In some embodiments, the first set of characteristics and the second set of characteristics include a color for each pixel in the first set of pixels and the second set of pixels, respectively. In some embodiments, the first set of characteristics and the second set of characteristics include a shape for each pixel in the first set of pixels and the second set of pixels, respectively. In some embodiments, the first set of characteristics and the second set of characteristics include a texture for each pixel in the first set of pixels and the second set of pixels, respectively.

In some embodiments, the first set of pixels include a plurality of pixels from the first image frame. In some embodiments, the second set of pixels include a plurality of pixels from the second image frame. In some embodiments, the determining the attributes of the road using the at least some of the combined set of characteristics comprises: determining, using the at least some of the combined set of characteristics, locations of corner points of lane markers of a lane on which the vehicle operates on the road. In some embodiments, the causing the vehicle to perform the driving related operation in response to the determining the attributes of the road comprises sending instructions to a motor in a steering system of the vehicle, wherein the instructions cause the motor to steer the vehicle along the lane using the locations of the corner points of the lane markers. In some embodiments, the determining the attributes of the road using the at least some of the combined set of characteristics comprises: determining, using the at least some of the combined set of characteristics, a presence of traffic cones on the road; and determining, in response to the determining the presence of the traffic cones, locations of the traffic cones using the at least some of the combined set of characteristics. In some embodiments, the first set of pixels include all pixels from the first image frame. In some embodiments, the second set of pixels include all pixels from the second image frame.

In yet another exemplary aspect, the above-described method is embodied in a non-transitory computer readable storage medium comprising code that when executed by a processor, causes the processor to perform the methods described in this patent document.

In yet another exemplary embodiment, a device that is configured or operable to perform the above-described methods is disclosed.

The above and other aspects and their implementations are described in greater detail in the drawings, the descriptions, and the claims.

### BRIEF DESCRIPTION OF THE DRAWING

FIG. 1 shows a block diagram of an example vehicle ecosystem in which driving operations can be determined based on the image processing performed on images obtained from a camera on or in a vehicle.

FIG. 2 shows an example flowchart of image processing operations using multiple images or image frames obtained from a camera on or in a vehicle.

FIG. 3 shows an example flowchart for performing driving operation in a vehicle.

### DETAILED DESCRIPTION

When a camera provides a series of images or image frames to computer(s) located in a vehicle, the computer can perform image processing techniques to analyze images provided by the camera. To understand a scene in a driving scenario (e.g., an autonomous driving scenario), the image can be analyzed at a pixel-level. For example, the image processing techniques described in this patent document can be used to analyze each pixel in an image to determine the information associated with a pixel in the image. Each pixel may have multiple semantic meanings so that image processing techniques may be used to determine the multiple semantic information associated with each pixel. For example, image processing techniques described in this patent document can be used to obtain any one or more of the following:
a semantic segmentation map that describes a category associated with each pixel of the image;
a lane segmentation map to locate or identify pixels that belong to a lane category, where the lane category is associated with a lane on a road;
a lane key-point map to locate or identify corner points for lane markers located on the lane on the road;
a traffic cone key-point map to describe the existence and positions of traffic cones on the road; and/or
an optical flow to describe the movement of a content (or a characteristic) represented by each pixel, where information related to the movement can describe the extent to which a location of a first pixel in a first image changes to another location of a second pixel in a second image, and where the second pixel corresponds to the first pixel.

Section I provides an overview of the devices/systems located on or in a vehicle, such as an autonomous semi-trailer truck. The devices/systems can be used to perform the image processing techniques that are described in Section II of this patent document, where the example image processing techniques can effectively and/or efficiently analyze multiple images or image frames.

### I. Vehicle Driving Ecosystem

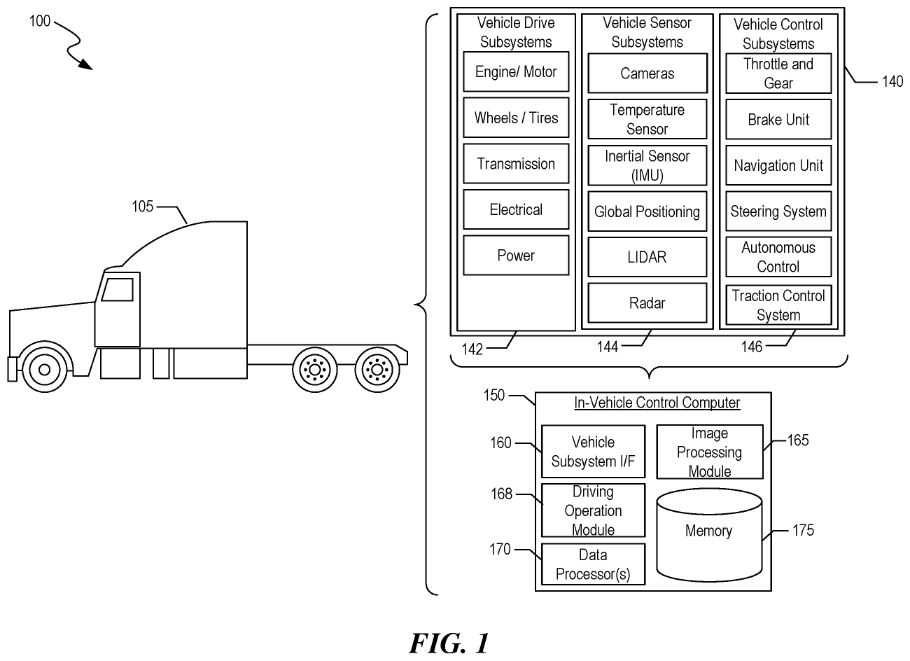

FIG. 1 shows a block diagram of an example vehicle ecosystem 100 in which driving operations can be determined based on the image processing performed on images obtained from a camera on or in a vehicle 105. As shown in FIG. 1, the vehicle 105 may be a semi-trailer truck. The vehicle ecosystem 100 includes several systems and components that can generate and/or deliver one or more sources of information/data and related services to the in-vehicle control computer 150 that may be located in a vehicle 105. The in-vehicle control computer 150 can be in data communication with a plurality of vehicle subsystems 140, all of which can be resident in the vehicle 105. A vehicle subsystem interface 160 is provided to facilitate data communication between the in-vehicle control computer 150 and the plurality of vehicle subsystems 140. In some embodiments, the vehicle subsystem interface 160 can include a controller area network (CAN) controller to communicate with devices in the vehicle subsystems 140.

The vehicle 105 may include various vehicle subsystems that support of the operation of vehicle 105. The vehicle subsystems may include a vehicle drive subsystem 142, a vehicle sensor subsystem 144, and/or a vehicle control subsystem 146. The components or devices of the vehicle drive subsystem 142, the vehicle sensor subsystem 144, and the vehicle control subsystem 146 as shown as examples. In some embodiment, additional components or devices can be added to the various subsystems or one or more components or devices (e.g., LiDAR or Radar shown in FIG. 1) can be removed. The vehicle drive subsystem 142 may include components operable to provide powered motion for the vehicle 105. In an example embodiment, the vehicle drive subsystem 142 may include an engine or motor, wheels/tires, a transmission, an electrical subsystem, and a power source.

The vehicle sensor subsystem 144 may include a number of sensors configured to sense information about an environment or condition of the vehicle 105. The sensors associated with the vehicle sensor subsystem 144 may be located on or in the vehicle 105. The vehicle sensor subsystem 144 may include one or more cameras or image capture devices, one or more temperature sensors, an inertial measurement unit (IMU), a Global Positioning System (GPS) transceiver, a laser range finder/LIDAR unit, a RADAR unit, and/or a wireless communication unit (e.g., a cellular communication transceiver). The vehicle sensor subsystem 144 may also include sensors configured to monitor internal systems of the vehicle 105 (e.g., an O₂ monitor, a fuel gauge, an engine oil temperature, etc.).

The IMU may include any combination of sensors (e.g., accelerometers and gyroscopes) configured to sense position and orientation changes of the vehicle 105 based on inertial acceleration. The GPS transceiver may be any sensor configured to estimate a geographic location of the vehicle 105. For this purpose, the GPS transceiver may include a receiver/transmitter operable to provide information regarding the position of the vehicle 105 with respect to the Earth. The RADAR unit may represent a system that utilizes radio signals to sense objects within the local environment of the vehicle 105. In some embodiments, in addition to sensing the objects, the RADAR unit may additionally be configured to sense the speed and the heading of the objects proximate to the vehicle 105. The laser range finder or LIDAR unit may be any sensor configured to sense objects in the environment in which the vehicle 105 is located using lasers. The cameras may include one or more devices configured to capture a plurality of images of the environment of the vehicle 105. The cameras may be still image cameras or motion video cameras.

The vehicle control subsystem 146 may be configured to control operation of the vehicle 105 and its components. Accordingly, the vehicle control subsystem 146 may include various elements such as a throttle and gear, a brake unit, a navigation unit, a steering system and/or an autonomous control unit. The throttle may be configured to control, for instance, the operating speed of the engine and, in turn, control the speed of the vehicle 105. The gear may be configured to control the gear selection of the transmission. The brake unit can include any combination of mechanisms configured to decelerate the vehicle 105. The brake unit can use friction to slow the wheels in a standard manner. The brake unit may include an Anti-lock brake system (ABS) that can prevent the brakes from locking up when the brakes are applied. The navigation unit may be any system configured to determine a driving path or route for the vehicle 105. The navigation unit may additionally be configured to update the driving path dynamically while the vehicle 105 is in operation. In some embodiments, the navigation unit may be configured to incorporate data from the GPS transceiver and one or more predetermined maps so as to determine the driving path for the vehicle 105. The steering system may represent any combination of mechanisms that may be operable to adjust the heading of vehicle 105 in an autonomous mode or in a driver-controlled mode.

The autonomous control unit may represent a control system configured to identify, evaluate, and avoid or otherwise negotiate potential obstacles in the environment of the vehicle 105. In general, the autonomous control unit may be configured to control the vehicle 105 for operation without a driver or to provide driver assistance in controlling the vehicle 105. In some embodiments, the autonomous control unit may be configured to incorporate data from the GPS transceiver, the RADAR, the LIDAR, the cameras, and/or other vehicle subsystems to determine the driving path or trajectory for the vehicle 105.

The traction control system (TCS) may represent a control system configured to prevent the vehicle 105 from swerving or losing control while on the road. For example, TCS may obtain signals from the IMU and the engine torque value to determine whether it should intervene and send instruction to one or more brakes on the vehicle 105 to mitigate the vehicle 105 swerving. TCS is an active vehicle safety feature designed to help vehicles make effective use of traction available on the road, for example, when accelerating on low-friction road surfaces. When a vehicle without TCS attempts to accelerate on a slippery surface like ice, snow, or loose gravel, the wheels can slip and can cause a dangerous driving situation. TCS may also be referred to as electronic stability control (ESC) system.

Many or all of the functions of the vehicle 105 can be controlled by the in-vehicle control computer 150. The in-vehicle control computer 150 may include at least one data processor 170 (which can include at least one microprocessor) that executes processing instructions stored in a non-transitory computer readable medium, such as the memory 175. The in-vehicle control computer 150 may also represent a plurality of computing devices that may serve to control individual components or subsystems of the vehicle 105 in a distributed fashion. In some embodiments, the memory 175 may contain processing instructions (e.g., program logic) executable by the data processor 170 to perform various methods and/or functions of the vehicle 105, including those described for the image processing module 165 and the driving operation module 168 as explained in this patent document. For instance, the data processor 170 executes the operations associated with image processing module 165 for analyzing the pixels in an images or image frames as described in this patent document. And, the data processor 170 executes the operations associated with driving operation module 168 for determining and/or performing driving related operations of the vehicle 105 based on the information provided by the image processing module 165.

The memory 175 may contain additional instructions as well, including instructions to transmit data to, receive data from, interact with, or control one or more of the vehicle drive subsystem 142, the vehicle sensor subsystem 144, and the vehicle control subsystem 146. The in-vehicle control computer 150 can be configured to include a data processor 170 and a memory 175. The in-vehicle control computer 150 may control the function of the vehicle 105 based on inputs received from various vehicle subsystems (e.g., the vehicle drive subsystem 142, the vehicle sensor subsystem 144, and the vehicle control subsystem 146).

### II. Example Image Processing Techniques

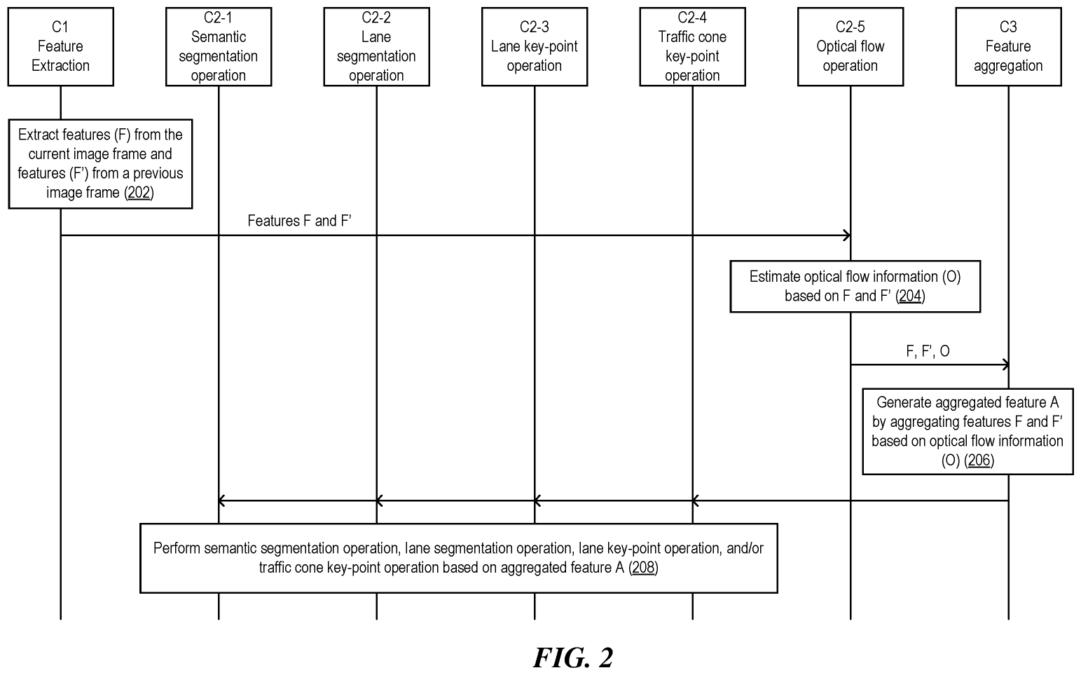

FIG. 2 shows an example flowchart of image processing operations using multiple images or image frames obtained from a camera on or in a vehicle. The top of FIG. 2 generally describes operations associated with C1-C3 can be performed by the image processing module (165 in FIG. 1) in some embodiments. In some other embodiments, the operation of each of C1-C3 can be performed by a corresponding image processing module in one or more computers located in the vehicle.

At C1, the image processing module performs a feature extraction operation that can use a deep neural network to extract features from images. The features of each image may include one or more characteristics associated with each pixel in the image, where the characteristic(s) of each pixel may include a color, shape, and/or texture associated with that pixel.

At C2-1 to C2-4, the image processing module performs the operations as mentioned below:
At C2-1, the image processing module performs a semantic segmentation operation on the aggregated feature A of the pixels in an image frame, where the aggregated feature A is obtained using operations 202-206 in FIG. 2 below. The semantic segmentation operation may include identifying a category of information (e.g., road, terrain, plantation, vehicle, traffic light, person, etc.) to which a pixel belongs for each pixel within the image or image frame. The output of the semantic segmentation operation includes a semantic map that indicates a category of each pixel.
At C2-2, the image processing module performs a lane segmentation operation that outputs in the semantic segmentation map an indication of whether each pixel belongs to a certain type of lane (e.g., an indication of whether each pixel belongs to a lane marker or does not belong to a lane marker) using the aggregated feature A of the pixels in an image frame.
At C2-3, the image processing module performs lane key-point operation where the image processing module estimates or determines locations of corner points of lane markers on a road using at least some of the aggregated feature A of at least some pixels in an image frame. In some embodiments, the image processing module can determine or estimate locations of corner points of each lane marker of a lane on which the vehicle operates or on all lanes of a road on which the vehicle operates. The lane markers can be parallel rectangular markers on each side of a lane on a road that indicate the extent of the lane on the road on which the vehicle can operate.
At C2-4, the image processing module performs a traffic cone key-point operation where the image processing module determines a location of each traffic cone (e.g., center point of a traffic cone) using at least some of the aggregated feature A of at least some pixels in an image frame in response to determining that traffic cones exist using the at least some of the aggregated feature A of at least some pixels in an image frame.
At C2-5, the image processing module performs an optical flow operation where an offset is determined for each pixel in a first image frame by comparing, for each pixel in the first image frame, characteristic(s) of a pixel with the same characteristic of another pixel in second image frame. The offset or motion information for each pixel indicates an amount by which or an extent to which the characteristic(s) of the pixel moved in the first image frame compared to the same characteristic(s) of the corresponding pixel from the second image frame. The second image frame may be received or obtained by the camera prior to (or immediately prior to) when the first image frame is received or obtained by the camera.

At C3, the image processing module performs a feature aggregation operation, where the image processing module aggregates features across image frames based on optical flow prediction.

At operation 202, an image processing module performs feature extraction operation by extracting features (F) (or characteristic(s)) of a plurality of pixels (e.g., each pixel) from a current image frame obtained from a camera located on or in a vehicle. At operation 202, the image processing module also performs feature extraction operation by extracting features (F′) (or characteristic(s) of a plurality of pixels (or each pixel) from a previous image frame obtained from the camera. In some embodiments, the extracting of the features (F′) of each pixel of the previous image frame is performed prior to the extracting of the features (F) of each pixel of the current image frame. The previous image frame may be received by the image processing module or obtained by the camera prior to (or immediately prior to) when the current image frame is received by the image processing module or obtained by the camera. For both features F and F′, the characteristic(s) of each pixel may include a color, shape, and/or texture associated with that pixel.

At operation 204, the image processing operation performs an optical flow operation by estimating a set of optical flow information (O) based on F and F′, where the optical flow information indicates, for each pixel in the current image frame, an extent to which characteristic(s) (or content(s)) of that pixel has moved relative to a same characteristic(s) of another corresponding pixel from the previous image frame. The image processing operation can perform the optical flow operation by comparing a feature of each pixel from the current image frame with the same feature of a corresponding pixel of the previous image frame. Thus, the image processing module can determine an amount by which the feature associated with the pixel from the current image frame has moved relative to the same feature of the corresponding pixel from the previous image frame. The output of the optical flow operation may include a set of optical flow information (O) that indicates an extent of motion (or how far a pixel has moved) for the pixels in the current image frame.

At operation 206, for each pixel in the current image frame, the image processing module aggregates features F and F′ for a pixel in a current image frame and a corresponding pixel in the previous image frame, where the aggregation of features F and F′ is based on the set of optical flow information O associated with a pixel in the current image frame. The image processing module obtain an aggregated feature A for each pixel in the current image frame by aggregating features F and F′ based on the set of optical flow information O. Thus, the aggregated feature A for each pixel in the current image frame may include feature(s) F of a pixel and feature(s) F′ of a corresponding pixel from the previous image frame, where the corresponding pixel in the previous image frame corresponds to the pixel in the current image frame.

At operation 208, the image processing module can determine one or more attributes of a road (e.g., category of pixels associated with the road or vehicle, lane markers, location of lane markers, and/or location of traffic cones) by performing semantic segmentation operation, lane segmentation operation, lane key-point operation, and/or traffic cone key-point operation based on aggregated feature A of at least some of the pixels of the current image frame using techniques described in C2-1 to C2-4 above. In some embodiments, operations 202 to 208 may be performed for each image frame received by the image processing module from the camera.

A technical benefit of the image processing operation described in this patent application is that image processing performance can be improved by aggregating or combing features of a pixel from a current image frame with the features of its corresponding pixel from previous image frame. The image processing module can perform operations related to C2-1, C2-2, C2-3, and/or C2-4 using a same aggregated information so that computational costs can be reduced and aggregated information can be shared between the C2-1, C2-2, C2-3, and/or C2-4 related operations. Furthermore, by aggregating the information between two image frames, the image processing can be improved for challenging scenarios where an object is small or static or occluded.

Another technical benefit of the image processing techniques described in this patent document is that optical flow prediction is used to aggregate features from at least two image frames (e.g., two consecutive image frames). Thus, a training framework can be used to merge unsupervised optical flow learning and supervised scene understanding tasks. Thus, the techniques described in this patent document can enable an application of optical flow learning and aggregation to any scene understanding task (e.g., any one or more of C2-1 to C2-4).

In some embodiments, the driving operation module (shown as 168 in FIG. 1) can perform driving related operations in the vehicle using information provided by operation(s) of any one or more of C2-1 to C2-4. For example, the driving operation module can send instructions to a motor in the steering system to steer the vehicle along a current lane using locations of corner points of lane markers on a road obtained from lane key-point operation (in C2-3 mentioned above) or using location of traffic cones indicated by the traffic cone key-point operation (in C2-4 mentioned above). In another example, the driving operation module can send instructions to a motor in the brake system to cause the brake system to apply brakes in response to determining that a current image frame includes a traffic light that is red, where the driving operation module determines that the traffic light is red using the semantic segmentation operation (in C2-1 mentioned above) that indicates that a category of an object in a current image frame is a traffic light which is red.

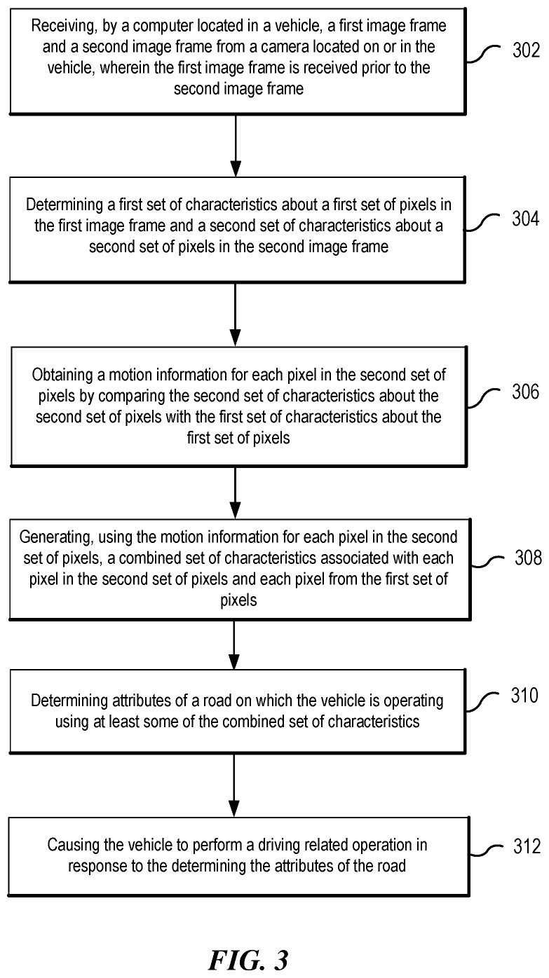

FIG. 3 shows an example flowchart for performing driving operation in a vehicle. Operation 302 includes receiving, by a computer located in a vehicle, a first image frame and a second image frame from a camera located on or in the vehicle, wherein the first image frame is received prior to the second image frame. Operation 304 includes determining a first set of characteristics about a first set of pixels in the first image frame and a second set of characteristics about a second set of pixels in the second image frame. Operation 306 includes obtaining a motion information for each pixel in the second set of pixels by comparing the second set of characteristics about the second set of pixels with the first set of characteristics about the first set of pixels. Operation 308 includes generating, using the motion information for each pixel in the second set of pixels, a combined set of characteristics associated with each pixel in the second set of pixels and each pixel from the first set of pixels. Operation 310 includes determining attributes of a road on which the vehicle is operating using at least some of the combined set of characteristics. Operation 312 includes causing the vehicle to perform a driving related operation in response to the determining the attributes of the road.

In some embodiments, the obtaining the motion information for each pixel in the second set of pixels includes: determining, for each pixel in the second set of pixels, an extent to which a characteristic of a pixel in the second set of pixels has moved relative to the same characteristic of a corresponding pixel in the first set of pixels, wherein the motion information of the pixel indicates the extent to which the characteristic the pixel has moved from the first image frame to the second image frame. In some embodiments, the combined set of characteristics is generated for each pixel in the second set of pixels by: determining, for each pixel in the second set of pixels, that one pixel corresponds to another pixel in the first set of pixels using the motion information for the one pixel; and generating the combined set of characteristics for each pixel in the second set of pixels by combining, for each pixel in the second set of pixels, one or more characteristic of the one pixel in the second set of pixels with one or more characteristic of the another pixel in the first set of pixels.

In some embodiments, the determining the attributes of the road using the at least some of the combined set of characteristics comprises: determining, for each pixel in the second set of pixels, a category of information associated with a pixel. In some embodiments, the category of information includes a road, a terrain, a plantation, a vehicle, a traffic light, or a person. In some embodiments, the determining the attributes of the road using the at least some of the combined set of characteristics comprises: determining, for each pixel in the second set of pixels and by using the combined set of characteristics for each pixel in the second set of pixels, whether a pixel is associated with a lane marker of a lane on the road.

In some embodiments, the determining the first set of characteristics and the second set of characteristics include determining, for each pixel in the first image frame, the first set of characteristics, and determining, for each pixel in the second image frame, the second set of characteristics. In some embodiments, the first image frame is received immediately prior to the second image frame. In some embodiments, the first set of characteristics and the second set of characteristics include a color for each pixel in the first set of pixels and the second set of pixels, respectively. In some embodiments, the first set of characteristics and the second set of characteristics include a shape for each pixel in the first set of pixels and the second set of pixels, respectively. In some embodiments, the first set of characteristics and the second set of characteristics include a texture for each pixel in the first set of pixels and the second set of pixels, respectively.

In some embodiments, the first set of pixels include a plurality of pixels from the first image frame. In some embodiments, the second set of pixels include a plurality of pixels from the second image frame. In some embodiments, the determining the attributes of the road using the at least some of the combined set of characteristics comprises: determining, using the at least some of the combined set of characteristics, locations of corner points of lane markers of a lane on which the vehicle operates on the road. In some embodiments, the causing the vehicle to perform the driving related operation in response to the determining the attributes of the road comprises sending instructions to a motor in a steering system of the vehicle, wherein the instructions cause the motor to steer the vehicle along the lane using the locations of the corner points of the lane markers. In some embodiments, the determining the attributes of the road using the at least some of the combined set of characteristics comprises: determining, using the at least some of the combined set of characteristics, a presence of traffic cones on the road; and determining, in response to the determining the presence of the traffic cones, locations of the traffic cones using the at least some of the combined set of characteristics. In some embodiments, the first set of pixels include all pixels from the first image frame. In some embodiments, the second set of pixels include all pixels from the second image frame.

In this document the term “exemplary” is used to mean “an example of” and, unless otherwise stated, does not imply an ideal or a preferred embodiment.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer- or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few implementations and examples are described and other implementations, enhancements and variations can be made based on what is described and illustrated in this disclosure.

What is claimed is:

1. A method of driving operation, comprising:
receiving, by a computer located in a vehicle, a first image frame and a second image frame from a camera located on or in the vehicle, wherein the first image frame is received prior to the second image frame;
determining a first set of characteristics about a first set of pixels in the first image frame and a second set of characteristics about a second set of pixels in the second image frame;
obtaining a motion information for each pixel in the second set of pixels by comparing the second set of characteristics about the second set of pixels with the first set of characteristics about the first set of pixels;
generating, using the motion information for each pixel in the second set of pixels, a combined set of characteristics associated with each pixel in the second set of pixels and each pixel from the first set of pixels;
determining attributes of a road on which the vehicle is operating using at least some of the combined set of characteristics; and
causing the vehicle to perform a driving related operation in response to the determining the attributes of the road.

2. The method of claim 1, wherein the obtaining the motion information for each pixel in the second set of pixels includes:
determining, for each pixel in the second set of pixels, an extent to which a characteristic of a pixel in the second set of pixels has moved relative to a same characteristic of a corresponding pixel in the first set of pixels, wherein the motion information of the pixel indicates the extent to which the characteristic the pixel has moved from the first image frame to the second image frame.

3. The method of claim 1, wherein the combined set of characteristics is generated for each pixel in the second set of pixels by:
determining, for each pixel in the second set of pixels, that one pixel corresponds to another pixel in the first set of pixels using the motion information for the one pixel; and
generating the combined set of characteristics for each pixel in the second set of pixels by combining, for each pixel in the second set of pixels, one or more characteristic of the one pixel in the second set of pixels with one or more characteristic of the another pixel in the first set of pixels.

4. The method of claim 1, wherein the determining the attributes of the road using the at least some of the combined set of characteristics comprises:
determining, for each pixel in the second set of pixels, a category of information associated with a pixel.

5. The method of claim 4, wherein the category of information includes a road, a terrain, a plantation, a vehicle, a traffic light, or a person.

6. The method of claim 1, wherein the determining the attributes of the road using the at least some of the combined set of characteristics comprises:
determining, for each pixel in the second set of pixels and by using the combined set of characteristics for each pixel in the second set of pixels, whether a pixel is associated with a lane marker of a lane on the road.

7. The method of claim 1, wherein the determining the first set of characteristics and the second set of characteristics include determining, for each pixel in the first image frame, the first set of characteristics, and determining, for each pixel in the second image frame, the second set of characteristics.

8. An apparatus for vehicle operation, comprising:
a processor configured to implement a method, the processor configured to:
receive a first image frame and a second image frame from a camera located on or in a vehicle, wherein the first image frame is received prior to the second image frame;
determine a first set of characteristics about a first set of pixels in the first image frame and a second set of characteristics about a second set of pixels in the second image frame;
obtain a motion information for each pixel in the second set of pixels by comparing the second set of characteristics about the second set of pixels with the first set of characteristics about the first set of pixels;
generate, using the motion information for each pixel in the second set of pixels, a combined set of characteristics associated with each pixel in the second set of pixels and each pixel from the first set of pixels;
determine attributes of a road on which the vehicle is operating using at least some of the combined set of characteristics; and
cause the vehicle to perform a driving related operation in response to the determine the attributes of the road.

9. The apparatus of claim 8, wherein the first image frame is received immediately prior to the second image frame.

10. The apparatus of claim 8, wherein the first set of characteristics and the second set of characteristics include a color for each pixel in the first set of pixels and the second set of pixels, respectively.

11. The apparatus of claim 8, wherein the first set of characteristics and the second set of characteristics include a shape for each pixel in the first set of pixels and the second set of pixels, respectively.

12. The apparatus of claim 8, wherein the first set of characteristics and the second set of characteristics include a texture for each pixel in the first set of pixels and the second set of pixels, respectively.

13. The apparatus of claim 8, wherein the first set of pixels include a plurality of pixels from the first image frame.

14. The apparatus of claim 8, wherein the second set of pixels include a plurality of pixels from the second image frame.

15. A non-transitory computer readable program storage medium having code stored thereon, the code, when executed by a processor, causing the processor to implement a method, comprising:
receiving, by a computer located in a vehicle, a first image frame and a second image frame from a camera located on or in the vehicle, wherein the first image frame is received prior to the second image frame;
determining a first set of characteristics about a first set of pixels in the first image frame and a second set of characteristics about a second set of pixels in the second image frame;
obtaining a motion information for each pixel in the second set of pixels by comparing the second set of characteristics about the second set of pixels with the first set of characteristics about the first set of pixels;
generating, using the motion information for each pixel in the second set of pixels, a combined set of characteristics associated with each pixel in the second set of pixels and each pixel from the first set of pixels;
determining attributes of a road on which the vehicle is operating using at least some of the combined set of characteristics; and
causing the vehicle to perform a driving related operation in response to the determining the attributes of the road.

16. The non-transitory computer readable program storage medium of claim 15, wherein the determining the attributes of the road using the at least some of the combined set of characteristics comprises:
determining, using the at least some of the combined set of characteristics, locations of corner points of lane markers of a lane on which the vehicle operates on the road.

17. The non-transitory computer readable program storage medium of claim 16, wherein the causing the vehicle to perform the driving related operation in response to the determining the attributes of the road comprises sending instructions to a motor in a steering system of the vehicle, wherein the instructions cause the motor to steer the vehicle along the lane using the locations of the corner points of the lane markers.

18. The non-transitory computer readable program storage medium of claim 15, wherein the determining the attributes of the road using the at least some of the combined set of characteristics comprises:
determining, using the at least some of the combined set of characteristics, a presence of traffic cones on the road; and
determining, in response to the determining the presence of the traffic cones, locations of the traffic cones using the at least some of the combined set of characteristics.

19. The non-transitory computer readable program storage medium of claim 15, wherein the first set of pixels include all pixels from the first image frame.

20. The non-transitory computer readable program storage medium of claim 15, wherein the second set of pixels include all pixels from the second image frame.
